(19) United States
(12) Patent Application Publication
(10) Pub. No.: US 2026/0161976 A1
(43) Pub. Date: Jun. 11, 2026

(54) MACHINE LEARNING MODELS FOR MODEL PREDICTION EXPLAINABILITY

(71) Applicant: QUALCOMM Incorporated, San Diego, CA (US)

(72) Inventors: Cansu SANCAKTAR, Amsterdam (NL); Wei David ZHANG, Amsterdam (NL); Daniel Hendricus Franciscus DIJKMAN, Haarlem (NL); Seungyong MOON, Amsterdam (NL)

(21) Appl. No.: 18/977,376

(22) Filed: Dec. 11, 2024

(51) Int. Cl. G06N 5/045

(52) U.S. Cl. CPC G06N 5/045

(57) ABSTRACT

Systems and techniques are described herein for machine learning model processing. For example, a computing device can An apparatus for machine learning processing, the apparatus comprising: process, using a first machine learning model of a machine learning system, a set of input tokens to determine a hidden state of the first machine learning model and to generate a plurality of output tokens, wherein the set of input tokens is associated with a user query to perform a task, the hidden state is associated with a sub-task of the task, and the plurality of output tokens are associated with instructions to perform the task; process, using an auxiliary network, the hidden state of the first machine learning model to generate instructions associated with performance of the sub-task; and process the plurality of output tokens to generate a set of instructions to perform the task.

### FIELD

The present disclosure generally relates to machine learning model prediction explainability (e.g., to provide explanations for how the machine learning model generated predictions of actions for the machine learning model to perform). For example, aspects of the present disclosure relate to systems and techniques for fine-tuning of machine learning models (e.g., a vision-language-action (VLA) model) for model prediction explainability.

### BACKGROUND

Many machine learning models operate as black box models. Black box models are machine learning models whose internal decision-making processes are not known to users. For example, users can observe inputs and outputs of the black box models, but the decision-making processes for how the black box model generated the output from the input are not known to the users. The lack of transparency and explainability in machine learning models operating as black box models can result in reduced user trust in the accuracy of the machine learning model. Further, machine learning models that do not explain decision-making processes are at risk of learning biases from training data which may not be obvious to a user. In examples of machine learning models for controlling robotics, explainability in the decision-making process can assist users in trouble-shooting issues with performing tasks. For example, when the tasks to be performed by the machine learning model are physical tasks (e.g., move an object to a coordinate), the predicted actions of the machine learning model to perform the physical tasks can be accurate but the physical task can be failed because of hardware failures of the robotics. In such an example, users can have difficulty determining whether failures to perform a task are based on inaccurate predicted actions (e.g., incorrect predicted actions) of the machine learning model or failures in the hardware of the robotics.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for machine learning model processing is provided. The apparatus can include at least one memory and at least one processor coupled to the at least one memory configured to: process, using a first machine learning model of a machine learning system, a set of input tokens to determine a hidden state of the first machine learning model and to generate a plurality of output tokens, wherein the set of input tokens is associated with a user query to perform a task, the hidden state is associated with a sub-task of the task, and the plurality of output tokens are associated with instructions to perform the task; process, using an auxiliary network, the hidden state of the first machine learning model to generate instructions associated with performance of the sub-task; and process the plurality of output tokens to generate a set of instructions to perform the task.

In some aspects, an apparatus for determining machine learning model sub-task reasoning is provided. The apparatus can include at least one memory and at least one processor coupled to the at least one memory configured to: obtain a first plurality of input tokens associated with an image and a second plurality of input tokens associated with a user query; process, using a machine learning model, the first plurality of input tokens and the second plurality of input tokens to generate a first set of instructions associated with performance of a task from the user query; and generate, based on one or more hidden states of the machine learning model, a second set of instructions associated with one or more sub-tasks of the task.

In some aspects, a method for machine learning processing is provided. The method can include: processing, using a first machine learning model of a machine learning system, a set of input tokens to determine a hidden state of the first machine learning model and to generate a plurality of output tokens, wherein the set of input tokens is associated with a user query to perform a task, the hidden state is associated with a sub-task of the task, and the plurality of output tokens are associated with instructions to perform the task; processing, using an auxiliary network, the hidden state of the first machine learning model to generate instructions associated with performance of the sub-task; and processing the plurality of output tokens to generate a set of instructions to perform the task.

In some aspects, a method for determining machine learning model sub-task reasoning is provided. The method can include obtaining a first plurality of input tokens associated with an image and a second plurality of input tokens associated with a user query; processing, using a machine learning model, the first plurality of input tokens and the second plurality of input tokens to generate a first set of instructions associated with performance of a task from the user query; and generating, based on one or more hidden states of the machine learning model, a second set of instructions associated with one or more sub-tasks of the task.

In some aspects, a non-transitory computer-readable medium is provided having stored thereon instructions that, when executed by at least one processor, cause the at least one processor to: process, using a first machine learning model of a machine learning system, a set of input tokens to determine a hidden state of the first machine learning model and to generate a plurality of output tokens, wherein the set of input tokens is associated with a user query to perform a task, the hidden state is associated with a sub-task of the task, and the plurality of output tokens are associated with instructions to perform the task; process, using an auxiliary network, the hidden state of the first machine learning model to generate instructions associated with performance of the sub-task; and process the plurality of output tokens to generate a set of instructions to perform the task.

In some aspects, a non-transitory computer-readable medium is provided having stored thereon instructions that, when executed by at least one processor, cause the at least one processor to: obtain a first plurality of input tokens associated with an image and a second plurality of input tokens associated with a user query; process, using a machine learning model, the first plurality of input tokens and the second plurality of input tokens to generate a first set of instructions associated with performance of a task from the user query; and generate, based on one or more hidden states of the machine learning model, a second set of instructions associated with one or more sub-tasks of the task.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SoC), in accordance with aspects of the present disclosure.

FIG. 2 illustrates an example machine learning architecture for performing tasks including auxiliary reasoning, in accordance with aspects of the present disclosure.

FIG. 3 illustrates another example machine learning architecture for performing tasks including auxiliary reasoning, in accordance with aspects of the present disclosure.

FIG. 4 illustrates an example of fine-tuning a machine learning architecture for performing tasks including auxiliary reasoning, in accordance with aspects of the present disclosure.

FIG. 5 illustrates an example act and reason machine learning architecture for performing tasks, in accordance with aspects of the present disclosure.

FIG. 6 illustrates an example of a prompt triggered machine learning architecture for performing tasks including reasoning, in accordance with aspects of the present disclosure.

FIG. 7 is a flow diagram illustrating an example process of machine learning processing, in accordance with aspects of the present disclosure.

FIG. 8 is a flow diagram illustrating another example process of machine learning processing, in accordance with aspects of the present disclosure.

FIG. 9 is a block diagram illustrating an example neural network, in accordance with aspects of the present disclosure.

FIG. 10 is a block diagram illustrating an example convolutional neural network, in accordance with aspects of the present disclosure.

FIG. 11 is a block diagram of an example transformer in accordance with aspects of the disclosure.

FIG. 12 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, many machine learning models operate as black box models (e.g., machine learning models whose internal decision-making processes are not known to users). For example, users can observe inputs and outputs of the black box models, but the decision-making processes for how the black box model generated the output from the input are not known to the users. The lack of transparency and explainability in machine learning models operating as black box models can result in reduced user trust in the accuracy of the machine learning model. Further, machine learning models which do not explain decision-making processes are at risk of learning biases from training data which may not be obvious to a user.

Machine learning models can be used to generate output (e.g., instructions) for controlling actions of one or more systems, such as robotics systems, vehicle systems, and/or other types of systems. In examples of machine learning models for controlling robotics, explainability in the decision-making process can assist users in trouble-shooting issues with performing tasks. For example, when the tasks to be performed by the machine learning model are physical tasks (e.g., move an object to a coordinate), the predicted actions of the machine learning model to perform the physical tasks can be accurate but the physical task can be failed because of hardware failures of the robotics. In such an example, users can have difficulty determining whether failures to perform a task are based on inaccurate predicted actions (e.g., incorrect predicted actions) of the machine learning model or failures in the hardware of the robotics.

Auxiliary reasoning can include the use of additional models or processes to enhance or explain decision-making performance of a machine learning model. For example, auxiliary networks can be used to provide descriptions of steps in machine learning model reasoning as the machine learning model performs a task. In some examples, the descriptions can be used to train or fine tune the model to improve reasoning capabilities of the machine learning model by providing a mechanism for evaluating and adjusting the reasoning of the machine learning model when determining how to perform a task. For example, understanding the reasoning of the machine learning model can allow users to highlight features of inputs which should be considered in the reasoning of the machine learning model when performing a task.

Auxiliary reasoning capabilities and machine learning model explainability are also useful when evaluating machine learning models controlling physical components (e.g., robots, drones, autonomous vehicles, etc.) in the real-world. In such examples, failures to perform tasks can be due to either failures in the machine learning model reasoning or failures in the hardware the machine learning model is controlling. For example, machine learning model explainability in vision-language-action (VLA) models can be used to troubleshoot whether failed tasks are due to hardware or the machine learning model. VLA models are a class of machine learning models configured to integrate visual input, language, and control actions to perform tasks. For example, VLA models can receive images and a user query (also referred to as a user prompt) to determine a task to perform from the user query and how to perform the task from the images. VLA models can be used to control various types of systems (e.g., robotic systems, vehicle systems, etc.), such as by providing a user query to move an object represented in an image. In another example, the cause of failure can be based on the predicted action (e.g., generating an incorrect control signal). In such an example, the model reasoning can indicate that the machine learning is attempting to perform a correct action (e.g., a logical action that should perform the task), however the system to perform the action (e.g., a robot, a simulated robot, etc.) is failing to perform the action. For example, a VLA model can output control signals (e.g., as tokens, which can be transformed into output control signals) to control the robotic systems to perform the task (e.g., control signals to move a robotic arm to move the object).

Current systems used for machine learning model explainability are resource intensive and slow the performance of machine learning models as the machine learning model must generate accompanying descriptions of each logical step of the performance of tasks. For example, some systems can use embodied chain of thought machine learning (ECOT) models which can output logical steps of the machine learning model in performing a task. ECOT models generally require a higher amount of computing resources than other traditional machine learning models. ECOT models can experience slow downs as the ECOT models explain the actions the ECOT models take when performing a task. The slow downs can be especially problematic when actions of the ECOT are performed in real-time (e.g., not pre-generated) such as when used to control a system (e.g., a robotic system, a vehicle system, etc.). The resource intensive nature of ECOT models make ECOT models less scalable, especially in environments with constrained computing resources.

Systems, apparatuses, electronic devices, methods (also referred to as processes), and computer-readable media (collectively referred to herein as “systems and techniques”) are described herein for machine learning models for model prediction explainability. In some aspects, the systems and devices can include one or more machine learning models. The machine learning models can be used to process images and user queries to generate control signals to control a system (e.g., a robotic system, a vehicle system, and/or other type of system) to perform a task described in the user queries. For example, a robotic system can include an image sensor to generate images, a robot (e.g., any one or more of a robotic limb, robotic manipulator, drone, end-effector, and/or other portion of the robot), and an input/output (I/O) device to receive user inputs to generate the user queries. In some examples, the robotic system can be simulated in a computer environment. While examples described herein will refer to robotics systems for illustrative purposes, the systems and techniques can be applied to any type of system that can perform actions based on output from the machine learning models, such as vehicle systems.

In some aspects, the systems and techniques can include a first machine learning model configured to receive input tokens associated with an image and a user query. The user query can be a description of task to be performed using the first machine learning model. In some examples, the first machine learning model can be a neural network, transformer-based model, a large language model (LLM), etc.

The first machine learning model can process the input tokens associated with the image and the user query to generate a plurality of output tokens. The output tokens can represent control signals that can be provided to a system (e.g., a robotic system, a vehicle system, or other type of system) to perform a task represented in the user query. For example, the user query can include a request to perform a task such as “move the object to the trash can”. The output tokens can be token representations of control signals to control a robotic system to move the object to the trash can. In some examples, the output tokens can be received by a task engine. In some examples, the task engine can be a machine learning model (referred to as the second machine learning model) to process the output tokens. The second machine learning model can process the output tokens to generate the control signals. In some examples, the output of the first machine learning model can be the control signals. For example, the output of the first machine learning model can include instructions for performing a task requested to be performed in a user query.

In some examples, the first machine learning model can receive the input tokens from associated with a processed image from an image processing engine and input tokens associated with a user query from a query tokenization engine. The image processing engine can be an algorithm, engine, service, application, etc. for processing images into a set of tokens. In further examples, the image processing engine can include one or more additional machine learning models. For example, the first machine learning model can receive a first subset of the input tokens from the image processing engine and a second subset of the input tokens from the query tokenization engine. In such an example, the image processing engine can be a machine learning model to process images into tokens (e.g., the first subset of the input tokens). The image processing engine can use vision transformer architecture to process images. In some examples, the image processing engine can include one or more machine learning networks, machine learning models, or machine learning model components to process images and provide tokens associated with the image to the first machine learning model.

For example, the image processing engine can be a system of multiple separate machine learning models, such as a separate machine learning models to perform image segmentation image classification, and/or other image processing operations, a separate machine learning model to perform feature extraction of images, and a separate machine learning model to project extracted features in a different space. In some examples, the image processing techniques can be performed by the same machine learning model, or different components of the same machine learning model. In such an example, the image processing engine can include a machine learning model (e.g., a DinoV2 neural network model, a Sigmoid Language Image Pre-training (SigLIP) neural network model, a Contrastive Language-Image Pre-Training (CLIP) neural network model, any combination thereof, and/or other type of machine learning model) that can perform feature extraction to determine or extract features from an image and/or perform one or more image processing operations, such as image segmentation, image classification, etc. and a projector (e.g., a multilayer perceptron (MLP) projector or other type of projector) that can generate one or more tokens for input to the first machine learning model and in some cases perform dimensionality reduction on features of the image. In further examples, the projector (e.g., the MLP projector) can be a separate neural network. The output of the projector can be a set of tokens associated with the processed image, which can be input for processing by the first machine learning model. The set of tokens associated with the processed image can be a first subset of a set of input tokens received by the first machine learning model.

The first machine learning model can also receive input tokens from the query tokenization engine. In some examples, the query tokenization engine model is an algorithm or engine for converting text into tokens to be received by the first machine learning model. In further examples, the query tokenization engine is a machine learning model. In some examples, the query tokenization engine is a tokenizing model for processing user queries into tokens. The query tokenization engine can generate a set of tokens associated with a user query. The set of tokens associated with the user query can be a second subset of the set of input tokens received by the first machine learning model. In some examples, the order of the input tokens can be reversed. For example, the set of input tokens can include the tokens associated with a user query first and then the tokens associated with the image, or vice versa. In further examples, the set of input tokens to the first machine learning model are in a mixed order of tokens associated with the image and tokens associated with the user query.

The first machine learning model can process the set of input tokens from the image processing engine and the input tokes from the tokenization engine to generate the output tokens. During processing of the various tokens, the first machine learning model can output hidden states of intermediate layers (e.g. features output by the intermediate layers) of the first machine learning model to an auxiliary network. For example, the auxiliary network can be a machine learning model that can process the hidden states of the first machine learning model to generate descriptions of steps in performing a task. For example, the auxiliary network can process the hidden states of the first machine learning model (e.g., features output by the intermediate layers of the first machine learning model) to generate instructions for performing a sub-task of the task requested to be performed in the user query. In such an example, the instructions can include a text-based description of the sub-task the first machine learning model predicts should be performed as part of a sequence of sub-tasks to perform an overall task (e.g., the task requested to be performed in the user query).

The output of the auxiliary network can change as the sub-tasks of the overall task are performed. For example, a task for moving an object using a robotic arm can be represented as a sequence or series of sub-tasks which when performed result in performance of the overall task. In such an example, moving an object from a first location to a second location can include positioning the arm at the first location, adjusting grip of a manipulator to secure the object, lifting the object, positioning the arm at the second location, and releasing the grip of the manipulator to drop the object. In such an example, the output of the auxiliary network can adjust as sub-tasks of the overall task are performed based on changes in the hidden states of the first machine learning model as the task is performed.

For example, the first machine learning model can receive tokens associated with a sequence of images (e.g., a video) of an environment in which the task is to be performed. The sequences of images (or input tokens representing the sequence of images) can be received as inputs to the first machine learning model, and the processing of the sequence of images results in changes to hidden states of the first machine learning model because the first machine learning model processes different images with different features. The auxiliary network receives the hidden states of the first machine learning model and can update the description (e.g., instructions to perform one or more sub-tasks) based on the hidden states.

In some examples, the auxiliary network is a small language model. In further examples, the auxiliary network can include a neural network, such as a classification neural network to classify hidden states of the first machine learning model and a regression neural network to predict sub-tasks of the overall task. In such an example, the regression neural network and the classification neural network can be used to generate the instructions to perform the sub-task.

In some aspects, the output of the auxiliary network can be used to fine-tune or train the first machine learning model by adjusting parameters of the first machine learning model. For example, various supervised or unsupervised training techniques to evaluate the accuracy of the output of the auxiliary network to adjust the parameters of the first machine learning model. In such an example, various loss functions (e.g., mean squared error (MSE), mean absolute error (MAE), cross-entropy loss, etc.) can be used to compare differences in expected auxiliary network outputs and the training data. For example, fine tuning can include comparing the instructions associated with performance of the sub-task generated by the auxiliary network and expected instructions associated with performance of the sub-task from training data.

Various aspects of the present disclosure will be described with respect to the figures.

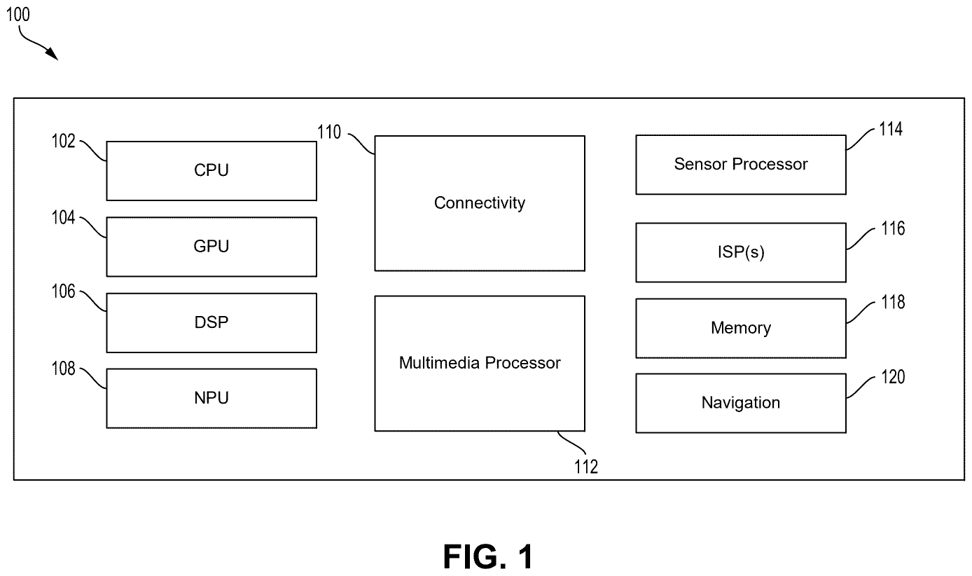

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 110, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured generate explanations for actions performed (e.g., to be performed, predicted to be performed, etc.) by a machine learning model. The explanations can be one or more of a text-based description, set of instructions to perform a sub-task or task, etc. according to aspects of the present disclosure discussed herein. The SOC can be used to operate various machine learning models for image processing, text processing, feature extraction, signal controls generation, etc. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

For example, the use of recurrent connections and/or temporal information in a machine learning model for audio processing, such as denoising of audio signals, can be used to preserve low-frequency audio signals in audio signals with wind noise, to achieve higher quality audio signals. Various recurrent architectures (e.g., RNNs) that include one or more recurrent cells among the feed-forward layers of the network can be used to perform audio processing operations to generate processed output audio signals having a relatively high quality. For example, recurrent cells can be implemented using a vanilla-RNN architecture, a Conv-GRU (Gated Recurrent Unit) architecture, a Conv-LSTM (Long Short-Term Memory) architectures, among various others.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

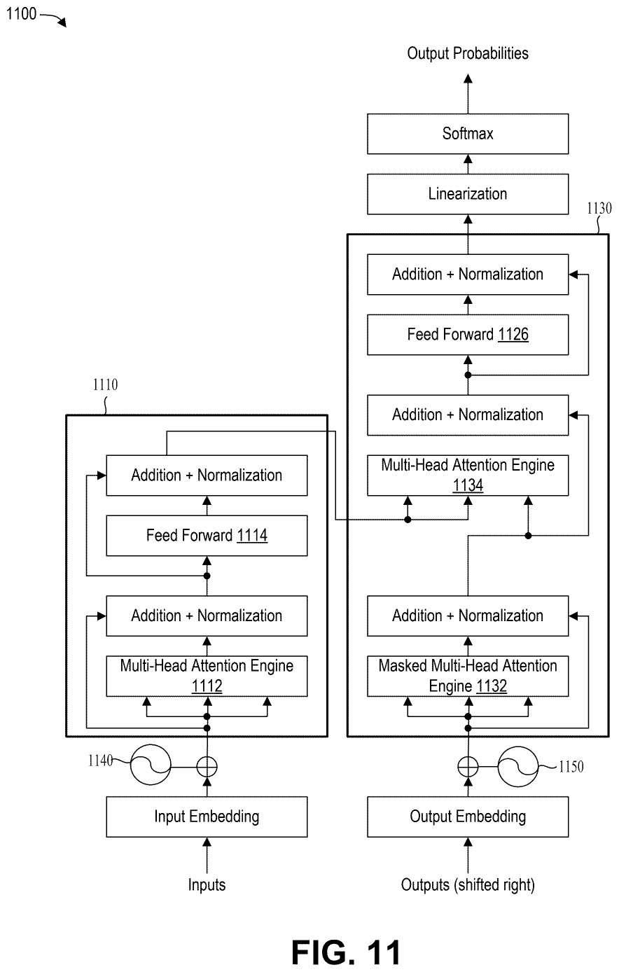

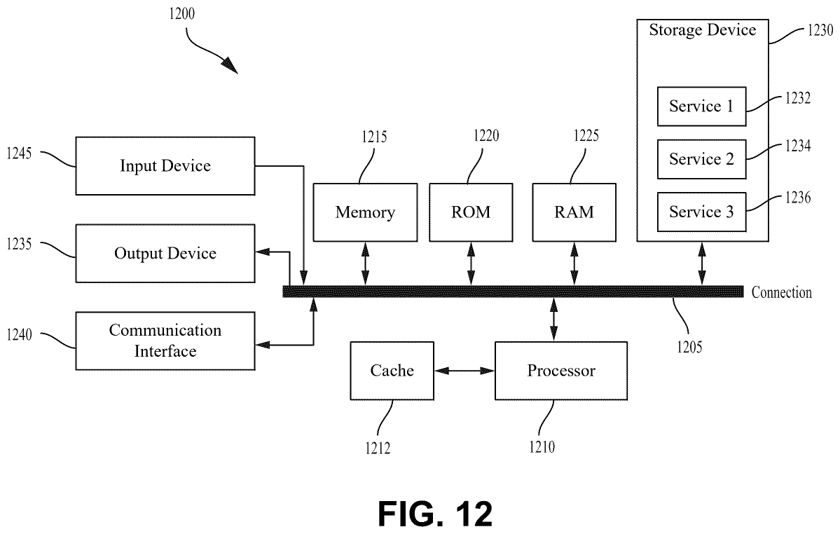

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architecture is provided in the description of FIG. 11 and FIG. 12.

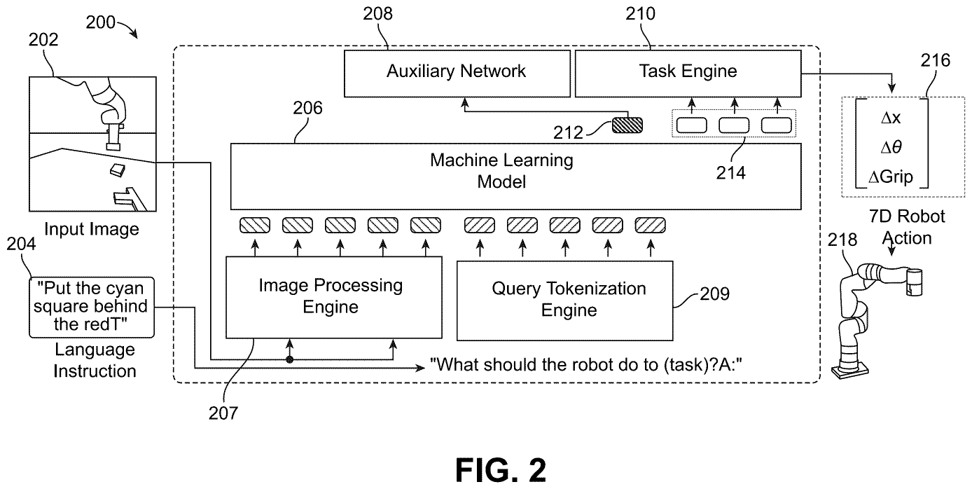

The SOC 100 of FIG. 1 can be used to perform the various systems and techniques described in the descriptions of FIG. 2-FIG. 9. For example, the SOC 100 can be used to perform operations of the machine learning model architecture 200 of FIG. 2 including wind noise detection and wind noise estimation.

FIG. 2 is a block diagram illustrating an example machine learning model architecture 200 for performing tasks including auxiliary reasoning. The machine learning model architecture 200 includes a machine learning model 206, an image processing engine 207, a query tokenization engine 209, an auxiliary network 208, and a task engine 210.

In some examples, the example machine learning model architecture 200 can be part of a robotic system to perform tasks. For example, the example machine learning model architecture 200 can include a robotic arm 218, a camera to receive an image 202 (or series of images such as a video, video stream, etc.), and an input/output (I/O) device to receive a user query 204. The user query can be a text-based user prompt requesting the robotic system or machine learning model architecture 200 perform a task (e.g., move an object, clear a table, sort a set of objects, etc.).

The image processing engine 207 can process the image 202 to generate a set of tokens. In some examples, the image processing engine 207 can be a machine learning model (or a plurality of machine learning models) for processing images to extract features from the image 202 and to generate the set of tokens associated with the features. For instance, the image processing engine 207 can be a system of multiple machine learning models, such as a machine learning models to perform image segmentation, image classification (e.g., to classify one or more objects in the image 202), a machine learning model to perform feature extraction of images, and a machine learning model to project extracted features in a different space (e.g., to convert or project an output from the machine learning models, such as an image segmentation output, an image classification output, extracted features, etc., to the set of tokens). In further examples, the image processing engine 207 can be an algorithm, application, service, etc. for extracting the features from the image 202 and generating the set of tokens associated with the features.

In some examples, the aforementioned image processing techniques can be performed by the same machine learning model (e.g., the image processing engine 207), or different components of the same machine learning model. In some aspects, the image processing engine 207 can include a first neural network or a first set of neural networks that can perform feature extraction to determine or extract features from the image 202 and/or perform one or more image processing operations on the image 202, such as image segmentation, image classification, etc. In some examples, the first neural network or the first set of neural networks can include a DinoV2 neural network model, a Sigmoid Language Image Pre-training (SigLIP) neural network model, a Contrastive Language-Image Pre-Training (CLIP) neural network model, any combination thereof, and/or other type of machine learning model. The image processing engine 207 can also include a second neural network referred to as a projector (e.g., a multilayer perceptron (MLP) projector or other type of projector) that can generate a set of tokens for input to the first machine learning model based on processing the output from the first neural network or the first set of neural networks. In some cases, the projector can perform dimensionality reduction on features of the image 202. In some examples, the projector can be a separate neural network from the image processing engine 207. As noted above, the output of the projector can be the set of tokens associated with the processed image (e.g., a tokenized representation of image 202). The set of tokens associated with the processed image can be a first subset of a set of input tokens received by the machine learning model 206.

The query tokenization engine 209 can receive the user query 204. The query tokenization engine 209 can process the user query 204 to generate a tokenized representation of the user query 204. For example, the tokenized representation can be a set of tokens. In some examples, the query tokenization engine 209 can be a machine learning model. The query tokenization engine 209 can be an algorithm, application, service, etc. for processing the user query 204 to generate a set of tokens which can be received as input by the machine learning model 206.

The machine learning model 206 can receive the tokenized representation of the image 202 and the tokenized representation of the user query 204 (e.g., a set of input tokens including a first subset of tokens associated with the image 202 and a second subset of tokens associated with the user query 204). The machine learning model 206 can process the set of input tokens to generate a set of output tokens 214. In some examples, the machine learning model 206 can be a neural network, transformer-based architecture model, a large language model (LLM), etc. The output tokens 214 can represent a prediction of the actions the machine learning model 206 (or a robotic system including the machine learning model 206) should perform to complete a task. For example, the output tokens 214 can include instructions associated with performance of a task requested to be performed in the user query 204.

The output tokens 214 can be received by the task engine 210. In some examples, the task engine 210 is a machine learning model for de-tokenizing the output tokens 214 to generate a set of control signals 216 for controlling a robot (e.g., the robotic arm 218). In some examples, the task engine 210 can generate a set of instructions for completing the task (e.g., the task requested to be performed in the user query 204) based on the output tokens 214. In further examples, the machine learning model 206 outputs the control signals in a format readable to a robot without requiring detokenization.

The auxiliary network 208 can receive a hidden state 212 of the machine learning model 206. For example, machine learning model 206 can process the set of input tokens and can output hidden states (e.g., the hidden state 212) of intermediate layers of the machine learning model to the auxiliary network 208. The auxiliary network 208 process the hidden states of the first machine learning model to generate descriptions of one or more steps to perform to perform an overall task. For example, the auxiliary network 208 can process hidden states (e.g., features output by intermediate layers of the machine learning model) to generate instructions for performing a sub-task of the overall task requested to be performed in the user query 204. In such an example, the instructions can include a text-based description of the sub-task the machine learning model 206 predicts should be performed as part of a sequence of sub-tasks to perform the overall task (e.g., the task requested to be performed in the user query 204).

The output of the auxiliary network 208 can be dynamic based on changes to hidden states of the machine learning model 206. For example, the output of the auxiliary network 208 (e.g., the instructions) can change as the sub-tasks of the overall task are performed. For example, a task for sorting objects into bins using the robotic arm 218 can be represented as a sequence or series of sub-tasks which when performed result in performance of the overall task. In such an example, sorting objects into bins can include identifying a bin associated with an object, positioning the arm at a location associated with the object, adjusting grip of a manipulator to secure the object, lifting the object, positioning the arm at a location associated with the bin, and releasing the grip of the manipulator to drop the object in the bin. In such an example, the output of the auxiliary network can adjust as sub-tasks of the overall task are performed based on changes in the hidden states of the first machine learning model as the task is performed.

For example, the machine learning model 206 can receive tokens associated with a sequence of images (e.g., a video) of an environment in which the task from the user query 204 is to be performed. The input tokens representing the sequence of images can be received as inputs to the machine learning model 206. Processing of the sequence of images can result in changes to hidden states of the machine learning model 206 because the machine learning model 206 the tokens received as input to the machine learning model 206 can be different as a scene captured in the sequence of images changes (e.g., as objects are moved, as the robotic arm 218 moves, etc.) The auxiliary network 208 receives the hidden states of the machine learning model 206 and can update the description (e.g., instructions to perform one or more sub-tasks) based on the hidden states.

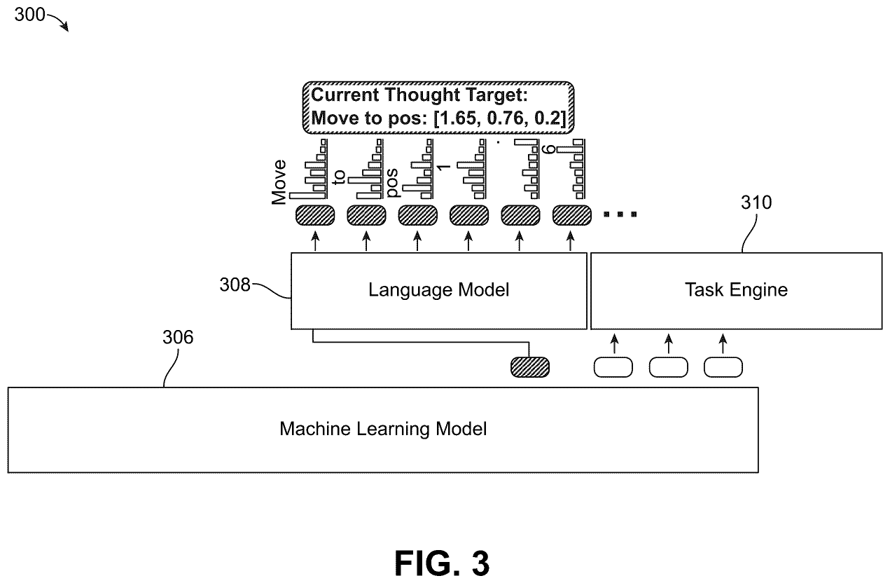

FIG. 3 is a block diagram illustrating another example machine learning model architecture 300 for performing tasks including auxiliary reasoning. FIG. 3 includes a machine learning model 306, a language model 308, and a task engine 310. By way of example, the machine learning model 306 can be the machine learning model 206 described in the description of FIG. 2. The machine learning model 306 can receive an image (e.g., a single image, a sequence of images, a video, etc.) as input and a user query, such as the image 202 and the user query 204 described in the description FIG. 2. The machine learning model 306 can generate and output tokens associated with a task from the user query to be performed.

The language model 308 can perform the operations of the auxiliary network 208 described in the description of FIG. 2. In some examples, the language model 308 is a small language model or an LLM. The language model 308 can receive a hidden state of the machine learning model 306 as an input. The language model 308 can process the hidden state to generate descriptions of one or more steps to execute to perform the task requested in the user query. For example, the language model 308 can process hidden states (e.g., features output by intermediate layers of the machine learning model 306) to generate instructions for performing a sub-task of the overall task requested to be performed in the user query. For example, the instructions can be text-based description of the sub-task.

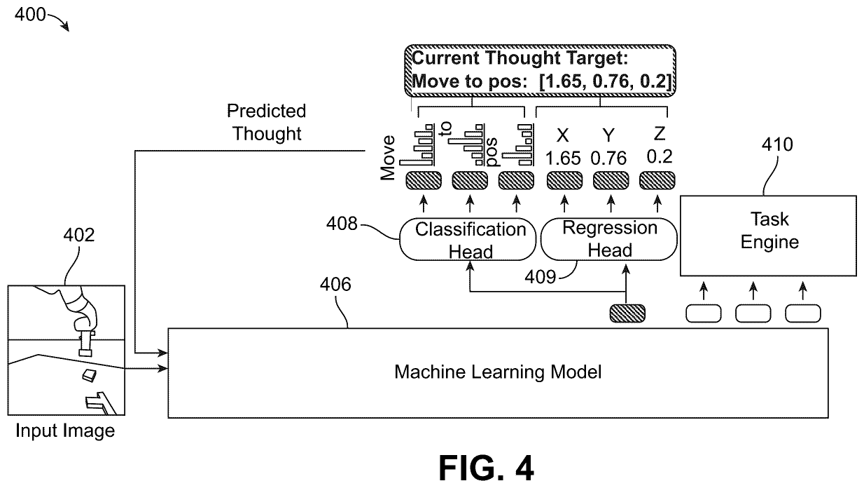

FIG. 4 is a block diagram illustrates an example of fine-tuning a machine learning architecture 400 for performing tasks including auxiliary reasoning. By way of example, the machine learning architecture 400 includes a machine learning model 406, a task engine 410, a classification head 408, and a regression head 409. The machine learning model 406 and the task engine 410 can be and can perform the operations of the machine learning model 206 and the task engine 210 described in the description of FIG. 2.

The machine learning model 406 can receive an image and a user query (or tokenized representations of the image and the user query). The machine learning model 406 can generate output tokens based on the image and user query which can be processed by the task engine 410 to generate instructions associated with performance of a task requested to be performed in the user query. One or more hidden states of the machine learning model 406 can be provided to the classification head 408 and the regression head 409. The classification head 408 and the regression head 409 can be neural networks, such as a classification neural network and a regression neural network. The classification head 408 and the regression head 409 can perform the operations described as being performed by the auxiliary network 208 in the description of FIG. 2. For example, the classification head 408 and the regression head 409 can process hidden states of the machine learning model 406 to generate a set of instructions associated with sub-tasks to perform an overall task of the user query. In another example, the classification head 408 can output discrete variables, such as tokens representing natural language. The regression head 409 can output continuous variables such as the X-Y-Z coordinates where a robot should go to perform a task or action.

The set of instructions generated by the classification head 408 and the regression head 409 can be provided to the machine learning model 406 as inputs. Subsequent images 402 can be received as input to the machine learning model 406. For example, when sub-tasks of the overall task are performed (or during performance of the sub-tasks) the machine learning model 406 can process subsequent images 402 associated with changes in an environment in which the sub-task and overall task (e.g., overall task from the user query) is to be performed. For example, the machine learning model 406 can be part of a robotic system. The sub-tasks can include movement of a robot within the environment. The subsequent images 402 can represent the changes in the environment as observed by the robotic system. The machine learning model can process subsequent images 402 and the instructions generated by the classification head 408 and the regression head 409 to generate additional output tokens and additional hidden states.

The output of the classification head 408 and the output of the regression head 409 can be used to fine-tune or train the machine learning model 406. For example, the machine learning model architecture 400 (or a fine-tuning engine of the machine learning model architecture 400) can adjust parameters of the machine learning model 406 based on differences between the instructions to perform the sub-tasks and expected instructions to perform the sub-task. For example, various supervised or unsupervised training techniques to evaluate the accuracy of the output of the classification head 408 and the regression head 409 can be used to adjust the parameters of the machine learning model 406. In such an example, various loss functions (e.g., mean squared error (MSE), mean absolute error (MAE), cross-entropy loss, etc.) can be used to compare differences in expected outputs and the training data. For example, fine tuning can include comparing the instructions associated with performance of the sub-task generated by the classification head 408 and the regression head 409 (or the auxiliary network 208 described in the description of FIG. 2) and expected instructions associated with performance of the sub-task from training data.

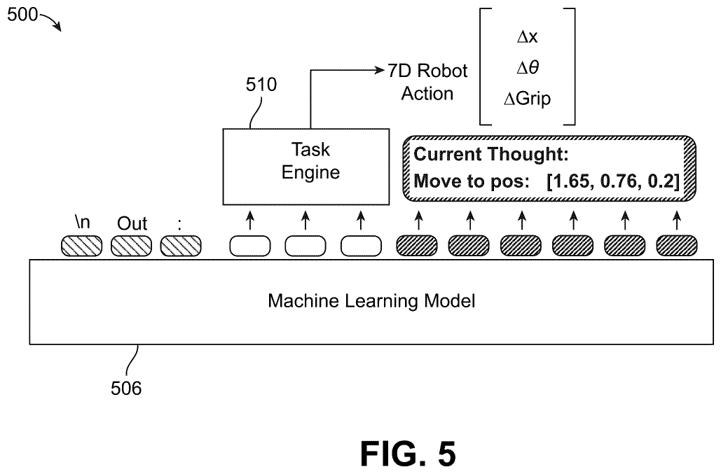

FIG. 5 illustrates example act and reason machine learning architecture 500 for performing tasks, in accordance with aspects of the present disclosure. The act and reason machine learning architecture 500 incudes a machine learning model 506. The machine learning model 506 can be the machine learning model 206 and the task engine 510 can be the task engine 210 described further in the description of FIG. 2.

In FIG. 5, the machine learning model 506 can generate hidden states after performance of the action. For example, the machine learning model 506 can output a set of output tokens to the task engine 510. The task engine 510 can process the output tokens to generate control signals to control a robot. The robot can perform the task based on the control signals. After performance of the task, or sub-tasks of the task, an auxiliary network can generate the instructions of the sub-task. The machine learning model 506 can perform an action (e.g., the task or a sub-task of the task) and then provide reasoning of the action (e.g., the set of instructions associated with sub-tasks of the task).

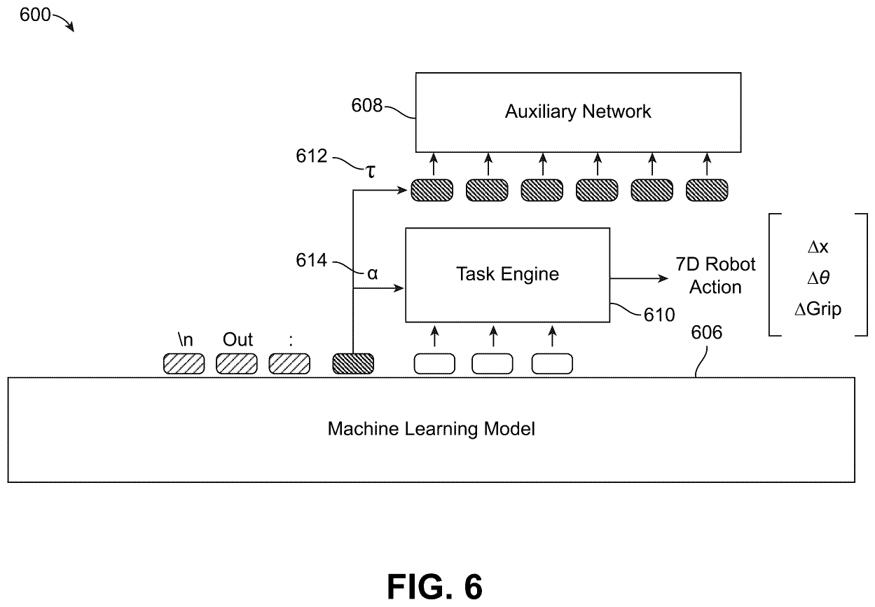

FIG. 6 illustrates an example machine learning model architecture 600 for a machine learning model which can determine to provide reasoning based on a user prompt. For example, the machine learning model architecture 600 can include a machine learning model 606, a task engine 610, and an auxiliary network 608. The user prompt can include information indicating whether to provide the user prompt to the auxiliary network 608 (e.g., by including t 612 or a 614) or the task engine 610. The machine learning model 606, the task engine 610, and the auxiliary network 608 can be the machine learning model 206, the task engine 210, and the auxiliary network 208 of FIG. 2, and can perform the corresponding operations described further in the description of FIG. 2.

The machine learning model 606 can generate one or more tokens associated with a user query received as input to the machine learning model 606. The user query can include a request for the machine learning model 606 to explain the steps the machine learning model 606 takes (e.g., the reasoning of the machine learning model 606 or instructions associated with the sub-tasks of the overall task) to perform a task. In some examples, the user query including the request can include a request to perform a task. In further examples, the machine learning model 606 can receive multiple user queries, such as a first user query requesting execution of a task, and a second user query requesting the machine learning model 606 generate instructions (e.g., a description) associated with sub-tasks to perform the task.

In such an example, when the user query includes a request to generate instructions associated with a sub-task, the auxiliary network 608 can generate the instructions associated with the sub-task based on one or more hidden states of the machine learning model 606. When the user query does not include a request to generate instructions associated with the sub-task, the task engine 610 generates instructions to perform the task (e.g., control signals to perform the task) without the auxiliary network 608 explaining the sub-tasks (e.g., without generating the instructions associated with the sub-task). In some examples, the machine learning model architecture 600 does not include the auxiliary network 608. In such an example, the output of the machine learning model 606 can output to the task engine 610.

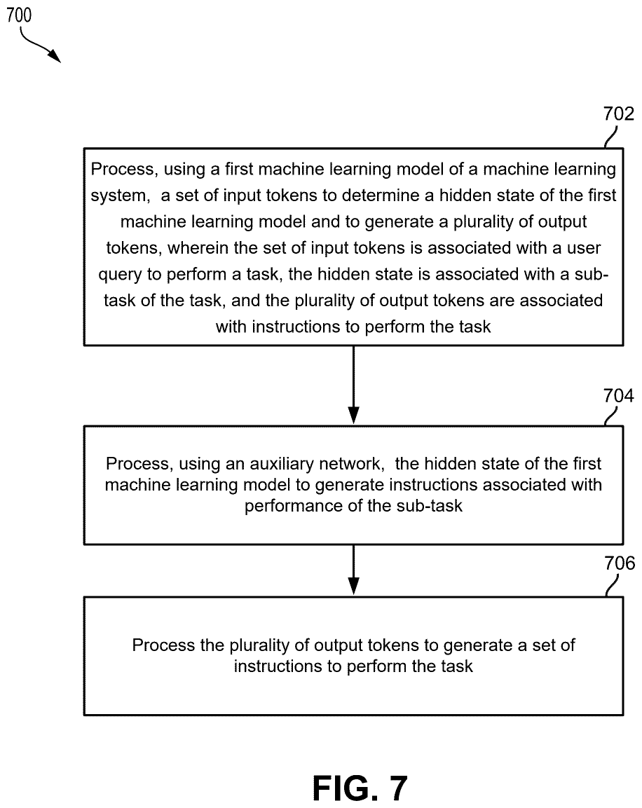

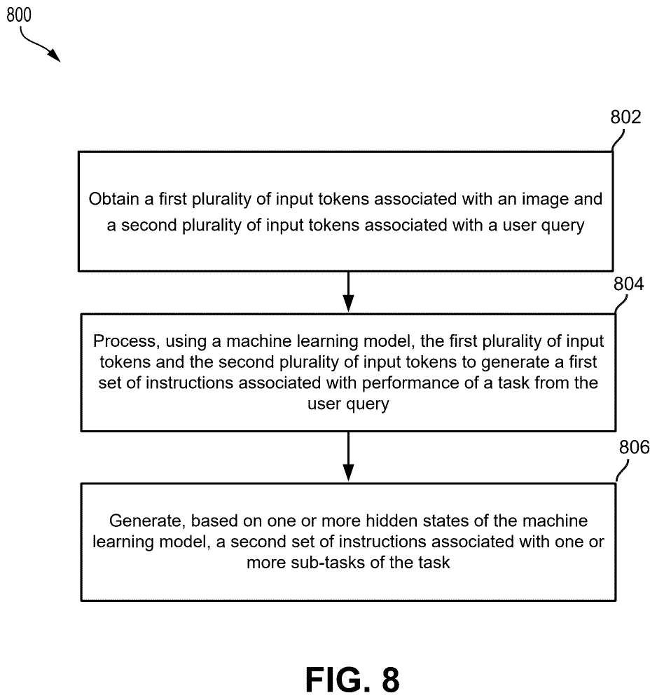

FIG. 7 and FIG. 8 are flow diagrams illustrating example processes 700 and 800 for machine learning processing. The processes 700 and 800 can be performed by a computing device (e.g., SOC 100 of FIG. 1, computing device or computing system 1200 of FIG. 12, etc.) or by a component or system (e.g., the machine learning model architecture 200 of FIG. 2, the machine learning model architecture 300 of FIG. 3, the machine learning model architecture 400 of FIG. 4, the machine learning model architecture 500 of FIG. 5, machine learning model architecture 600 of FIG. 6, etc.), a chipset, one or more processors central processing units (CPUs), digital signal processors (DSPs), graphics processing units (GPUs), any other type of processor(s), any combination thereof, or other component or system) of the computing device. The operations of the processes 700 and 800 can be implemented as software components that are executed and run on one or more processors (e.g., processor 1210 of FIG. 12 or other processor(s)) of the computing device. Further, the transmission and reception of signals by the computing device in the processes 700 and 800 can be enabled, for example, by one or more antennas, one or more microphones, and/or one or more transceivers (e.g., wireless transceiver(s)).

At block 702, the computing device (or component thereof) can process, using a first machine learning model of a machine learning system, a set of input tokens to determine a hidden state of the first machine learning model and to generate a plurality of output tokens. For example, the machine learning system can be the machine learning architecture 200 of FIG. 2, the machine learning architecture 300 of FIG. 3, the machine learning architecture 400 of FIG. 4, the machine learning architecture 400 of FIG. 4, the machine learning architecture 500 of FIG. 5, the machine learning architecture 600 of FIG. 6, etc. wherein the set of input tokens is associated with a user query to perform a task, the hidden state is associated with a sub-task of the task, and the plurality of output tokens are associated with instructions to perform the task. In some examples, the machine learning system using the first machine learning model controls a robotic arm or other robot.

In some examples the set of input tokens can be associated with a user query to perform a task. In further examples, the hidden state is associated with a sub-task of the task. In such an example, the task can be divided into sub-tasks. For example, a task to use a robotic arm to move an object from a first coordinate to a second coordinate can be divided into sub-tasks such as to move the robotic arm to the first coordinate, adjust a grip of the robotic arm to grasp the object, and move the robotic arm to the second coordinate.

In further examples, the plurality of output tokens can be associated with instructions to perform the task. The set of instructions to perform the task can be or include a set of control signals to control a robot.

At block 704, the computing device (or component thereof) can process, using an auxiliary network, the hidden state of the first machine learning model to generate instructions associated with performance of the sub-task. In some examples, the first machine learning model is configured to output the hidden state to the auxiliary network based on a condition of the user query. In further examples, the auxiliary network includes a language model. In another example, the auxiliary network can include a regression neural network and a classification neural network. In a further example, the first machine learning model can include a large language model (LLM).

At block 706, the computing device (or component thereof) can process the plurality of output tokens to generate a set of instructions to perform the task. In some examples, the set of instructions are associated with performance of the sub-task is a text-based description of the sub-task. For example, the sub-task can be an action from a series or sequence of actions which when performed result in performance of the task. In some examples, the text-based description includes a predicted pose of a robot to perform the sub-task.

In some examples, the computing device (or component thereof) can fine-tune parameters of the first machine learning model using a loss function based on a comparison of the instructions associated with performance of the sub-task and expected instructions associated with performance of the sub-task. In further examples, the computing device (or component thereof) can process, using the first machine learning model, the instructions associated with performance of the sub-task to generate a subsequent hidden state of the first machine learning model and a subsequent plurality of output tokens and process the subsequent plurality of output tokens to generate a subsequent set of instructions to perform the task. In further examples, the computing device (or component thereof) can process, using a second machine learning model, the plurality of output tokens to generate the set of instructions to perform the task. In another example, the computing device (or component thereof) can process, using a third machine learning model, an image to generate a plurality of image tokens, wherein the plurality of image tokens is a first subset of the set of input tokens. In such an example, the third machine learning model can be an image processing engine, such as the image processing engine 207 of FIG. 2. In another example, the computing device (or component thereof) can process, using a fourth machine learning model, the user query to generate a plurality of query tokens, wherein the plurality of query tokens is a second subset of the set of input tokens.

FIG. 8 is a flow diagram illustrating process 800 for machine learning processing. The process can be performed by a computing device (e.g., SOC 100 of FIG. 1, computing device or computing system 1200 of FIG. 12, etc.) or by a component or system (e.g., the machine learning model architecture 200 of FIG. 2, the machine learning model architecture 300 of FIG. 3, the machine learning model architecture 400 of FIG. 4, the machine learning model architecture 500 of FIG. 5, machine learning model architecture 600 of FIG. 6, etc.), a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 1210 of FIG. 12 or other processor(s)) of the computing device. Further, the transmission and reception of signals by the computing device in the process 800 can be enabled, for example, by one or more antennas, one or more microphones, and/or one or more transceivers (e.g., wireless transceiver(s)).

At block 802, the computing device (or component thereof) can obtain a first plurality of input tokens associated with an image and a second plurality of input tokens associated with a user query. For example, the computing device can obtain a first plurality of input tokens from an image processing engine, such as the image processing engine 207 of FIG. 2. In some examples, the image processing engine is a machine learning model, an algorithm, an application, etc.

At block 804, the computing device (or component thereof) can process, using a machine learning model, the first plurality of input tokens and the second plurality of input tokens to generate a first set of instructions associated with performance of a task from the user query. For example, the first set of instructions can include instructions for performing sub-tasks of the task, which when performed in order, can result in performance of the task. In some examples, the machine learning model is a language model, such as a large language model (LLM).

At block 806, the computing device (or component thereof) can generate, based on one or more hidden states of the machine learning model, a second set of instructions associated with one or more sub-tasks of the task. In further examples, the computing device (or component thereof) can determine the second set of instructions after the generation of the first set of instructions. In another example, the computing device (or component thereof) can determine to generate the second set of instructions based on a condition of the user query.

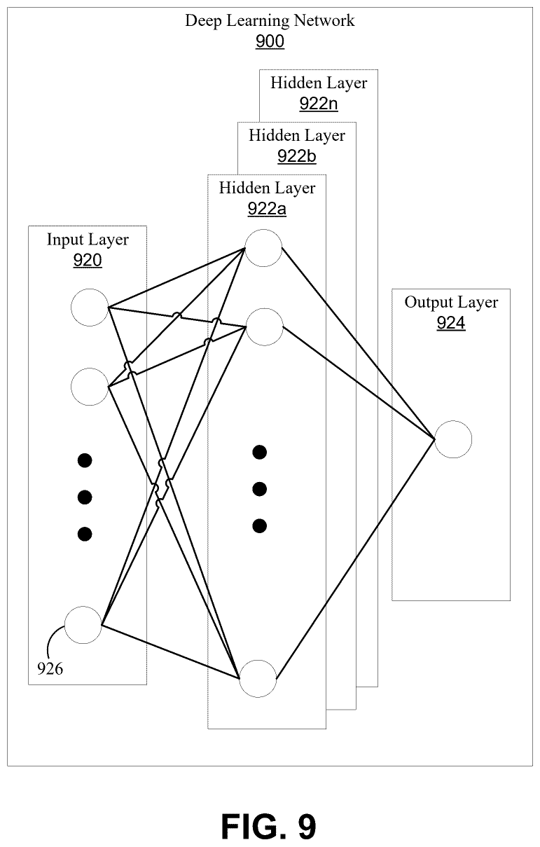

FIG. 9 is an illustrative example of a deep learning neural network 900 that can be used by the machine learning model 206, the auxiliary network 208, the task engine 210, the query tokenization engine 209, and the image processing engine 207. An input layer 920 includes input data. In one illustrative example, the input layer 920 can include data representing the pixels of an input image or video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In one illustrative example, the output layer 924 can provide a classification for an object in an input image or video frame. The classification can include a class identifying the type of object (e.g., a static object, a vehicle, a person, a dog, a cat, or other object).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the hidden layers 922a, 922b, through 922n can transform the information of each input node by applying activation functions to the information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify objects in images, the neural network 900 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [00 1000000 0].

In some cases, the neural network 900 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying objects in images, the forward pass can include passing a training image through the neural network 900. The weights are initially randomized before the neural network 900 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 900 can include any suitable deep network. One example includes a convolutional neural network (CNN), which includes an input layer and an output layer, with multiple hidden layers between the input and out layers. An example of a CNN is described below with respect to FIG. 9. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

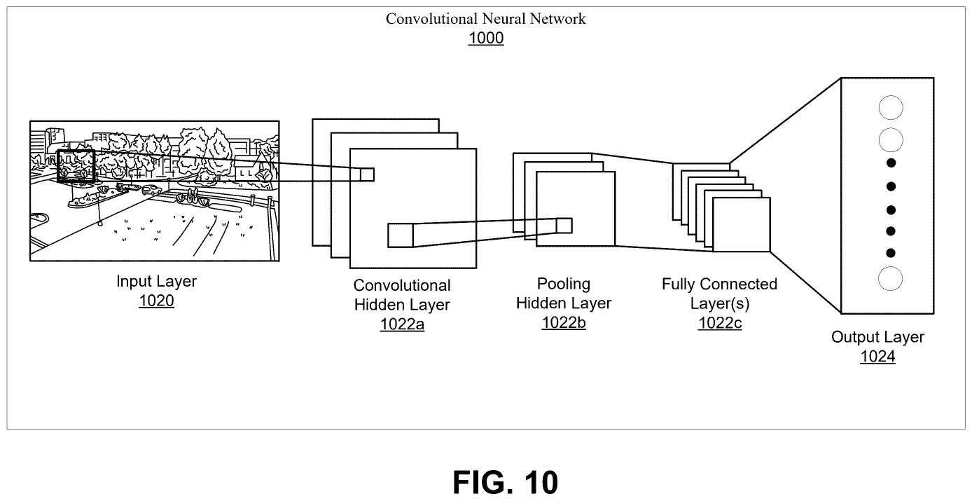

FIG. 10 is an illustrative example of a convolutional neural network 1000 (CNN 1000). The input layer 1020 of the CNN 1000 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1022a, an optional non-linear activation layer, a pooling hidden layer 1022b, and fully connected hidden layers 1022c to get an output at the output layer 1024. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 is the convolutional hidden layer 1022a. The convolutional hidden layer 1022a analyzes the image data of the input layer 1020. Each node of the convolutional hidden layer 1022a is connected to a region of nodes (pixels) of the input image called a receptive field. The convolutional hidden layer 1022a can be considered as one or more filters (each filter corresponding to a different activation or feature map), with each convolutional iteration of a filter being a node or neuron of the convolutional hidden layer 1022a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1022a. Each connection between a node and a receptive field for that node learns a weight and, in some cases, an overall bias such that each node learns to analyze its particular local receptive field in the input image. Each node of the hidden layer 1022a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 1022a is due to each node of the convolutional layer being applied to its corresponding receptive field. For example, a filter of the convolutional hidden layer 1022a can begin in the top-left corner of the input image array and can convolve around the input image. As noted above, each convolutional iteration of the filter can be considered a node or neuron of the convolutional hidden layer 1022a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1022a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1022a.

The mapping from the input layer to the convolutional hidden layer 1022a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1022a can include several activation maps in order to identify multiple features in an image. The example shown in FIG. 10 includes three activation maps. Using three activation maps, the convolutional hidden layer 1022a can detect three different kinds of features, with each feature being detectable across the entire image.

In some examples, a non-linear hidden layer can be applied after the convolutional hidden layer 1022a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1000 without affecting the receptive fields of the convolutional hidden layer 1022a.

The pooling hidden layer 1022b can be applied after the convolutional hidden layer 1022a (and after the non-linear hidden layer when used). The pooling hidden layer 1022b is used to simplify the information in the output from the convolutional hidden layer 1022a. For example, the pooling hidden layer 1022b can take each activation map output from the convolutional hidden layer 1022a and generates a condensed activation map (or feature map) using a pooling function. Max-pooling is one example of a function performed by a pooling hidden layer. Other forms of pooling functions be used by the pooling hidden layer 1022a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1022a. In the example shown in FIG. 10, three pooling filters are used for the three activation maps in the convolutional hidden layer 1022a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1022a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1022a having a dimension of 24×24 nodes, the output from the pooling hidden layer 1022b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. The positional information can be discarded without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1022b to every one of the output nodes in the output layer 1024. Using the example above, the input layer includes 28×28 nodes encoding the pixel intensities of the input image, the convolutional hidden layer 1022a includes 3×24×24 hidden feature nodes based on application of a 5×5 local receptive field (for the filters) to three activation maps, and the pooling layer 1022b includes a layer of 3×12×12 hidden feature nodes based on application of max-pooling filter to 2×2 regions across each of the three feature maps. Extending such an example, the output layer 1024 can include ten output nodes. In such an example, every node of the 3×12×12 pooling hidden layer 1022b is connected to every node of the output layer 1024.

The fully connected layer 1022c can obtain the output of the previous pooling layer 1022b (which should represent the activation maps of high-level features) and determines the features that most correlate to a particular class. For example, the fully connected layer 1022c layer can determine the high-level features that most strongly correlate to a particular class and can include weights (nodes) for the high-level features. A product can be computed between the weights of the fully connected layer 1022c and the pooling hidden layer 1022b to obtain probabilities for the different classes. For example, if the CNN 1000 is being used to predict that an object in an image or video frame is a vehicle, high values will be present in the activation maps that represent high-level features of vehicles (e.g., two or four tires, a windshield, side view mirrors, etc.).

In some examples, the output from the output layer 1024 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.9 0 0 0 0], the vector indicates that there is a 5% probability that the image is the third class of object (e.g., a person), an 80% probability that the image is the fourth class of object (e.g., a static object on a road or other driving surface), and a 9% probability that the image is the sixth class of object (e.g., a vehicle). The probability for a class can be considered a confidence level that the object is part of that class.

FIG. 11 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 1100 reduces the operations of learning dependencies by using an encoder 1110 and a decoder 1130 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1110 is composed of a stack of six identical layers and each layer has two sub-layers. The first sub-layer is a multi-head self-attention engine 1112, and the second sub-layer is a fully connected feed-forward network 1114. A residual connection (not shown) connects around each of the sub-layers followed by normalization.

In the example transformer 1100, the decoder 1130 is also composed of a stack of six 6 identical layers. The decoder also includes a masked multi-head self-attention engine 1132, a multi-head attention engine 1134 over the output of the encoder 1110, and a fully connected feed-forward network 1126. Each layer includes a residual connection (not shown) around the layer, which is followed by layer normalization. The masked multi-head self-attention engine 1132 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1140 to encode positions because the model does not contain recurrence and convolution, and relative or absolute position of the tokens is needed. In the transformer 1100, the positional encodings are added to the input embeddings at the bottom layer of the encoder 1110 and the decoder 1130. The positional encodings are summed with the embeddings because the positional encodings and embeddings have the same dimensions. A corresponding position decoder 1150 is configured to decode the positions of the embeddings for the decoder 1130.

In some aspects, the transformer 1100 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1100 can process input sequences of variable length, making it well-suited for natural language processing tasks where input lengths can vary greatly. Additionally, the self-attention mechanism allows the transformer 1100 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 12 illustrates an example computing system 1200 of an example computing device which can implement the various techniques described herein. For example, the computing system 1200 can implement the machine learning model architecture 200 shown in FIG. 2. The components of computing system 1200 are shown in electrical communication with each other using connection 1205, such as a bus. The example computing system 1200 includes a processing unit (CPU or processor) 1210 and computing device connection 1205 that couples various computing device components including computing device memory 129, such as read only memory (ROM) 1220 and random access memory (RAM) 1225, to processor 1210.

Computing system 1200 can include a cache of high-speed memory connected directly with, in close proximity to, or integrated as part of processor 1210. Computing system 1200 can copy data from memory 129 and/or the storage device 1230 to cache 1212 for quick access by processor 1210. In this way, the cache can provide a performance boost that avoids processor 1210 delays while waiting for data. These and other modules can control or be configured to control processor 1210 to perform various actions. Other computing device memory 129 may be available for use as well. Memory 129 can include multiple different types of memory with different performance characteristics. Processor 1210 can include any general purpose processor and a hardware or software service, such as service 1 1232, service 2 1234, and service 3 1236 stored in storage device 1230, configured to control processor 1210 as well as a special-purpose processor where software instructions are incorporated into the processor design. Processor 1210 may be a self-contained system, containing multiple cores or processors, a bus, memory controller, cache, etc. A multi-core processor may be symmetric or asymmetric.

To enable user interaction with the computing system 1200, input device 1245 can represent any number of input mechanisms, such as a microphone for speech, a touch-sensitive screen for gesture or graphical input, keyboard, mouse, motion input, speech and so forth. Output device 1235 can also be one or more of a number of output mechanisms known to those of skill in the art, such as a display, projector, television, speaker device, etc. In some instances, multimodal computing devices can enable a user to provide multiple types of input to communicate with computing system 1200. Communication interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1225, read only memory (ROM) 1220, and hybrids thereof. Storage device 1230 can include services 1232, 1234, 1236 for controlling processor 1210. Other hardware or software modules are contemplated. Storage device 1230 can be connected to the computing device connection 1205. In one aspect, a hardware module that performs a particular function can include the software component stored in a computer-readable medium in connection with the necessary hardware components, such as processor 1210, connection 1205, output device 1235, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1: An apparatus for machine learning processing, the apparatus comprising: at least one memory; and at least one processor coupled to the at least one memory and configured to: process, using a first machine learning model of a machine learning system, a set of input tokens to determine a hidden state of the first machine learning model and to generate a plurality of output tokens, wherein the set of input tokens is associated with a user query to perform a task, the hidden state is associated with a sub-task of the task, and the plurality of output tokens are associated with instructions to perform the task; process, using an auxiliary network, the hidden state of the first machine learning model to generate instructions associated with performance of the sub-task; and process the plurality of output tokens to generate a set of instructions to perform the task.
Aspect 2: The apparatus of Aspect 1, wherein the at least one processor is configured to fine-tune parameters of the first machine learning model using a loss function based on a comparison of the instructions associated with performance of the sub-task and expected instructions associated with performance of the sub-task.
Aspect 3: The apparatus of any of Aspects 1 to 2, wherein the at least one processor is configured to: process, using the first machine learning model, the instructions associated with performance of the sub-task to generate a subsequent hidden state of the first machine learning model and a subsequent plurality of output tokens; and process the subsequent plurality of output tokens to generate a subsequent set of instructions to perform the task.
Aspect 4: The apparatus of any of Aspects 1 to 3, wherein the first machine learning model is configured to output the hidden state to the auxiliary network based on a condition of the user query.
Aspect 5: The apparatus of any of Aspects 1 to 4, wherein the at least one processor is configured to: process, using a second machine learning model, the plurality of output tokens to generate the set of instructions to perform the task.
Aspect 6: The apparatus of any of Aspects 1 to 5, wherein the at least one processor is configured to: process, using a third machine learning model, an image to generate a plurality of image tokens, wherein the plurality of image tokens is a first subset of the set of input tokens.
Aspect 7: The apparatus of any of Aspects 1 to 6, wherein the at least one processor is configured to: process, using a fourth machine learning model, the user query to generate a plurality of query tokens, wherein the plurality of query tokens is a second subset of the set of input tokens.
Aspect 8: The apparatus of any of Aspects 1 to 7, wherein the auxiliary network includes a language model.
Aspect 9: The apparatus of any of Aspects 1 to 8, wherein the auxiliary network includes a regression neural network and a classification neural network.
Aspect 10: The apparatus of any of Aspects 1 to 9, wherein the first machine learning model includes a large language model (LLM).
Aspect 11: The apparatus of any of Aspects 1 to 10, wherein the set of instructions to perform the task are a set of control signals to control a robot.
Aspect 12: The apparatus of any of Aspects 1 to 11, wherein the set of instructions associated with performance of the sub-task is a text-based description of the sub-task.
Aspect 13: The apparatus of any of Aspects 1 to 12, wherein the text-based description includes a predicted pose of a robot to perform the sub-task.
Aspect 14: An apparatus for determining machine learning model sub-task reasoning, the apparatus comprising: at least one memory; and at least one processor coupled to the at least one memory and configured to: obtain a first plurality of input tokens associated with an image and a second plurality of input tokens associated with a user query; process, using a machine learning model, the first plurality of input tokens and the second plurality of input tokens to generate a first set of instructions associated with performance of a task from the user query; and generate, based on one or more hidden states of the machine learning model, a second set of instructions associated with one or more sub-tasks of the task.
Aspect 15: The apparatus of Aspect 14, wherein the at least one processor is configured to determine the second set of instructions after the generation of the first set of instructions.
Aspect 16: The apparatus of any of Aspects 14 to 15, wherein the at least one processor is configured to determine to generate the second set of instructions based on a condition of the user query.
Aspect 17: The apparatus of any of Aspects 14 to 16, wherein the machine learning model includes a large language model (LLM).
Aspect 18: A method comprising: processing, using a first machine learning model of a machine learning system, a set of input tokens to determine a hidden state of the first machine learning model and to generate a plurality of output tokens, wherein the set of input tokens is associated with a user query to perform a task, the hidden state is associated with a sub-task of the task, and the plurality of output tokens are associated with instructions to perform the task; processing, using an auxiliary network, the hidden state of the first machine learning model to generate instructions associated with performance of the sub-task; and processing the plurality of output tokens to generate a set of instructions to perform the task.
Aspect 19: The method of Aspect 18, comprising: fine-tuning parameters of the first machine learning model using a loss function based on a comparison of the instructions associated with performance of the sub-task and expected instructions associated with performance of the sub-task.
Aspect 20: The method of any of Aspects 18 to 19, further comprising: processing, using the first machine learning model, the instructions associated with performance of the sub-task to generate a subsequent hidden state of the first machine learning model and a subsequent plurality of output tokens; and processing the subsequent plurality of output tokens to generate a subsequent set of instructions to perform the task.
Aspect 21: The method of any of Aspects 18 to 19, wherein the first machine learning model is configured to output the hidden state to the auxiliary network based on a condition of the user query.
Aspect 22: The method of any of Aspects 18 to 21, comprising: processing, using a second machine learning model, the plurality of output tokens to generate the set of instructions to perform the task.
Aspect 23: The method of any of Aspects 18 to 22, comprising: processing, using a third machine learning model, an image to generate a plurality of image tokens, wherein the plurality of image tokens is a first subset of the set of input tokens.
Aspect 24: The method of any of Aspects 18 to 23, further comprising: processing, using a fourth machine learning model, the user query to generate a plurality of query tokens, wherein the plurality of query tokens is a second subset of the set of input tokens.
Aspect 25: The method of any of Aspects 18 to 24, wherein the auxiliary network includes a language model.
Aspect 26: The method of any of Aspects 18 to 25, wherein the auxiliary network includes a regression neural network and a classification neural network.
Aspect 27: The method of any of Aspects 18 to 26, wherein the first machine learning model includes a large language model (LLM).
Aspect 28: The method of any of Aspects 18 to 27, wherein the set of instructions to perform the task are a set of control signals to control a robot.
Aspect 29: The method of any of Aspects 18 to 28, wherein the set of instructions associated with performance of the sub-task is a text-based description of the sub-task.
Aspect 30: The method of any of Aspects 18 to 29, wherein the text-based description includes a predicted pose of a robot to perform the sub-task.
Aspect 31: A method comprising: obtaining a first plurality of input tokens associated with an image and a second plurality of input tokens associated with a user query; processing, using a machine learning model, the first plurality of input tokens and the second plurality of input tokens to generate a first set of instructions associated with performance of a task from the user query; and generating, based on one or more hidden states of the machine learning model, a second set of instructions associated with one or more sub-tasks of the task.
Aspect 32: The method of Aspect 31, comprising: determining the second set of instructions after the generation of the first set of instructions.
Aspect 33: The method of any of Aspects 31 to 32, comprising: determining to generate the second set of instructions based on a condition of the user query.
Aspect 34: The method of any of Aspects 31 to 33, wherein the machine learning model includes a large language model (LLM).
Aspect 35: An apparatus for machine learning model processing is provided. The apparatus includes one or more means for performing operations according to any of Aspects 18 to 34.
Aspect 36: A non-transitory computer-readable medium is provided having stored thereon instructions that, when executed by at least one processor, cause the at least one processor to perform operations according to any of Aspects 18 to 34.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed:

1. An apparatus for machine learning processing, the apparatus comprising:
at least one memory; and
at least one processor coupled to the at least one memory and configured to:
process, using a first machine learning model of a machine learning system, a set of input tokens to determine a hidden state of the first machine learning model and to generate a plurality of output tokens, wherein the set of input tokens is associated with a user query to perform a task, the hidden state is associated with a sub-task of the task, and the plurality of output tokens are associated with instructions to perform the task;
process, using an auxiliary network, the hidden state of the first machine learning model to generate instructions associated with performance of the sub-task; and
process the plurality of output tokens to generate a set of instructions to perform the task.

2. The apparatus of claim 1, wherein the at least one processor is configured to fine-tune parameters of the first machine learning model using a loss function based on a comparison of the instructions associated with performance of the sub-task and expected instructions associated with performance of the sub-task.

3. The apparatus of claim 1, wherein the at least one processor is configured to:
process, using the first machine learning model, the instructions associated with performance of the sub-task to generate a subsequent hidden state of the first machine learning model and a subsequent plurality of output tokens; and
process the subsequent plurality of output tokens to generate a subsequent set of instructions to perform the task.

4. The apparatus of claim 1, wherein the first machine learning model is configured to output the hidden state to the auxiliary network based on a condition of the user query.

5. The apparatus of claim 1, wherein the at least one processor is configured to:
process, using a second machine learning model, the plurality of output tokens to generate the set of instructions to perform the task.

6. The apparatus of claim 5, wherein the at least one processor is configured to:
process, using a third machine learning model, an image to generate a plurality of image tokens, wherein the plurality of image tokens is a first subset of the set of input tokens.

7. The apparatus of claim 6, wherein the at least one processor is configured to:
process, using a fourth machine learning model, the user query to generate a plurality of query tokens, wherein the plurality of query tokens is a second subset of the set of input tokens.

8. The apparatus of claim 1, wherein the auxiliary network includes a language model.

9. The apparatus of claim 1, wherein the auxiliary network includes a regression neural network and a classification neural network.

10. The apparatus of claim 1, wherein the first machine learning model includes a large language model (LLM).

11. The apparatus of claim 1, wherein the set of instructions to perform the task are a set of control signals to control a robot.

12. The apparatus of claim 1, wherein the set of instructions associated with performance of the sub-task is a text-based description of the sub-task.

13. The apparatus of claim 12, wherein the text-based description includes a predicted pose of a robot to perform the sub-task.

14. An apparatus for determining machine learning model sub-task reasoning, the apparatus comprising:
at least one memory; and
at least one processor coupled to the at least one memory and configured to:
obtain a first plurality of input tokens associated with an image and a second plurality of input tokens associated with a user query;
process, using a machine learning model, the first plurality of input tokens and the second plurality of input tokens to generate a first set of instructions associated with performance of a task from the user query; and
generate, based on one or more hidden states of the machine learning model, a second set of instructions associated with one or more sub-tasks of the task.

15. The apparatus of claim 14, wherein the at least one processor is configured to determine the second set of instructions after the generation of the first set of instructions.

16. The apparatus of claim 14, wherein the at least one processor is configured to determine to generate the second set of instructions based on a condition of the user query.

17. The apparatus of claim 14, wherein the machine learning model includes a large language model (LLM).

18. A method comprising:
processing, using a first machine learning model of a machine learning system, a set of input tokens to determine a hidden state of the first machine learning model and to generate a plurality of output tokens, wherein the set of input tokens is associated with a user query to perform a task, the hidden state is associated with a sub-task of the task, and the plurality of output tokens are associated with instructions to perform the task;
processing, using an auxiliary network, the hidden state of the first machine learning model to generate instructions associated with performance of the sub-task; and
processing the plurality of output tokens to generate a set of instructions to perform the task.

19. The method of claim 18, comprising:
fine-tuning parameters of the first machine learning model using a loss function based on a comparison of the instructions associated with performance of the sub-task and expected instructions associated with performance of the sub-task.

20. The method of claim 18, comprising:
processing, using the first machine learning model, the instructions associated with performance of the sub-task to generate a subsequent hidden state of the first machine learning model and a subsequent plurality of output tokens; and
processing the subsequent plurality of output tokens to generate a subsequent set of instructions to perform the task.
